(19) United States
(12) Patent Application Publication
(10) Pub. No.: US 2011/0065426 A1
(43) Pub. Date: Mar. 17, 2011

(54) METHOD AND NETWORK FOR DISPLAYING A CALLER ID IN WiMAX/GSM INTEGRATED SUPPORT TERMINAL

(75) Inventors: Gun-Woo BAE, Daegu (KR); Tea-Sul KIM, Gyeongsangbuk-do (KR)

(73) Assignee: Samsung Electronics Co., LTD., Gyeonggi-Do (KR)

(21) Appl. No.: 12/879,077

(22) Filed: Sep. 10, 2010

(30) Foreign Application Priority Data
Sep. 11, 2009 (KR) 10-2009-0085941

(51) Int. Cl. H04W 4/00

(52) U.S. Cl. 455/415

(57) ABSTRACT

A method of displaying a caller ID in a WiMAX/GSM integrated support portable terminal is provided. When a service is requested from a portable terminal, a message is transmitted for confirming whether to perform a caller ID (CID) display service through a corresponding channel through which the service has been requested. If the CID display service is determined to be performed after the message is received through the channel through which the service has been requested, the corresponding inherent identification information of the portable terminal in an SMS for transmission, and a subscriber identification information of the corresponding portable terminal is confirmed through the received SMS. The inherent identification information included in the SMS is extracted and the extracted inherent identification information to the subscriber identification information is matched. The matched identification information stored and a caller ID service is registered for a subsequent identification purpose.

### CLAIM OF PRIORITY

This application claims the priority under 35 U.S.C. §119(a) of an application entitled “Method Of Displaying Caller Id In WiMAX/GSM Integrated Support Terminal” filed in the Korean Intellectual Property Office on Sep. 11, 2009 and assigned Serial No. 10-2009-0085941, the contents of which are hereby incorporated by reference.

### BACKGROUND OF THE INVENTION

1. Field of the Invention

The present invention relates to a method of displaying a caller identification (ID) in a portable terminal, and more particularly to a method of displaying a caller ID in a portable terminal supporting both WiMAX and GSM protocols.

2. Description of the Related Art

Phone calls can be now readily made on the Internet using a VoIP (Voice over Internet Protocol) technology. Since the advent of PC-to-PC type Internet phone call applications, their use has been increasing to the extent that they account for a considerable part of long-distance phone calls. With more improvement in voice quality, it is expected that the VoIP technology would lead in the future voice communication.

The Internet phone, which initially started as a PC-to-PC type, has made remarkable progress in a phone-to-phone service with a great charge saving for a long-distance telephone service. Since this service requires a very simple system configuration and easy to recruit initial subscribers, ITSPs (Internet Telephony Service Providers) have constructed international VoIP networks, thus opening a real VoIP communication age.

With the advent of VoIP terminals and IP-Centrex, the Internet phone calls have been advanced rapidly in technology and marketability. Since the IP-Centrex can control VoIP terminals virtually connected through the Internet just like terminals accommodated in a telephone exchange, it can provide more convenient operation management and additional function, and thus it is expected it will gradually substitute for PBX.

The term “VoIP” indicates a protocol that makes it possible to perform voice communication using IP (Internet Protocol). The VoIP Internet phone call is a commercialized communication service based on a VoIP Internet phone call system constructed by applying the VoIP. The VoIP, which is an abbreviation of voice over IP, is a general term for technologies which make the voice communication possible on a packet switch network that is currently used as a data network.

FIG. 1 is a diagram schematically illustrating the configuration of a VoIP Internet phone call system in the related art.

The VoIP Internet phone call system in the related art includes a VoIP terminal 100 connected to an IP network that is called a packet network or the Internet, a telephone terminal connected to a PSTN that is called a circuit network or a telephone network, and an Internet gateway system 112 that relays intercommunication to an IP network 220 or communication between the IP network 110 and the PSTN 114. The Internet gateway system 112 relays phone calls not only in the case where communication means of a caller and a receiver are both the VoIP terminal but also in the case where the communication means 116 of the caller and the receiver are the VoIP terminal and the telephone terminal, respectively.

However, in the case of originating a phone call using the VoIP in a WiMAX network of the VoIP Internet phone call system having the above-described advantages, it is difficult for the receiver side to recognize the caller by recognizing the corresponding number. This is because an inherent service number of a provider that provides the VoIP service rather than a general MSISDN number is displayed on a receiver side. Also, the reception may be denied by a user on the receiver side due to the same calling number as that of the inherent service of the provider.

Further, even in the case where the caller side uses the WiMAX/GSM terminal and uses the existing SIM card, the caller's phone number may not be properly transferred in the case of the VoIP telephone.

### SUMMARY OF THE INVENTION

Accordingly, the present invention has been made to solve the above-mentioned problems occurring in the prior art, by providing a caller ID display service that is the same as the existing caller ID display service by making the MSISDN number of a caller SIM card be displayed on a receiver side terminal even during a VoIP service through the Internet, without passing through authentication through a PC or a terminal.

In accordance with an aspect of the present invention, there is provided a method of displaying a caller ID in a WiMAX/GSM integrated support portable terminal, which includes, when a service is requested from a portable terminal, transmitting a message for confirming whether to perform a caller ID (CID) display service through a corresponding channel through which the service has been requested; if the CID display service is determined to be performed, including corresponding inherent identification information of the portable terminal in an SMS for transmission; and confirming a subscriber identification information of the corresponding portable terminal through the received SMS by: extracting the inherent identification information included in the SMS, matching the extracted inherent identification information to the subscriber identification information of the portable terminal, storing the matched identification information, and registering a caller ID service so that a phone number of the portable terminal can be displayed automatically thereafter in a receiver terminal.

In accordance with an aspect of the present invention, there is provided a network having a first system and a second system for providing a caller ID service. The network further includes a terminal, in communication with the first system and the second system, transmitting a request to register for a caller ID (CID) display service via a specified channel of the second system by providing corresponding inherent identification information of the terminal in an SMS; and a server, in response to the SMS, confirming a subscriber identification information of the terminal by extracting the inherent identification information included in the SMS, matching the extracted inherent identification information to the subscriber identification information, storing both the matched identification information for registration of a caller ID service so that a phone number of the terminal can be displayed automatically. Thereafter, upon receiving a request for a call origination from the terminal to a receiver terminal, displaying a corresponding phone number of the terminal on the receiver side terminal if there is a match between the inherent identification information transmitted from the terminal and previously stored subscriber identification information,

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram schematically illustrating the configuration of a VoIP Internet phone call system in the related art;

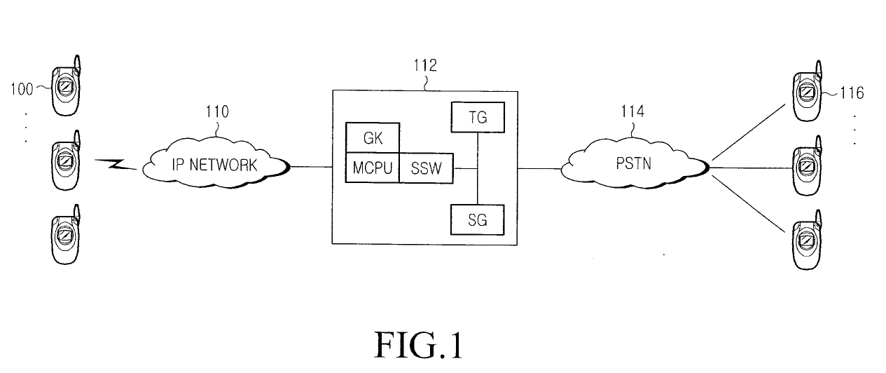

FIG. 2 is a diagram schematically illustrating the whole configuration of a system capable of displaying a caller ID in a WiMAX/GSM integrated support portable terminal according to an embodiment of the present invention; and

FIG. 3 is a flowchart illustrating a method of displaying a caller ID in a WiMAX/GSM integrated support portable terminal according to an embodiment of the present invention.

### DETAILED DESCRIPTION OF THE INVENTION

Hereinafter, exemplary embodiments of the present invention will be described with reference to the accompanying drawings. In the following description, various specific definitions found in the following description are provided only to help general understanding of the present invention, and it is apparent to those skilled in the art that the present invention can be implemented without such definitions.

Prior to the detailed description of the present invention, a portable terminal to be described hereinafter is a terminal that provides services between a wired/wireless public network and VoIP, but the present invention is not limited thereto. Accordingly, the portable terminal according to an embodiment of the invention is a terminal which can perform integrated support of digital mobile communication through a WiMAX network where the VoIP can provide a voice service through an IP network and a GSM (Global System for Mobile Communications) network. The portable terminal may be preferably a mobile communication terminal, and it is apparent that the portable terminal can be applied to all information and communication appliances and multimedia appliances, such as a digital broadcasting terminal, a PDA (Personal Digital Assistant), a smart phone, a 3G terminal, for example, an IMT-2000 (International Mobile Telecommunication 2000) terminal, a WCDMA (Wideband Code Division Multiple Access) terminal, a GSM/GPRS (Global System for Mobile Communication Packet Radio Service) terminal, and the like, and their applications.

Also, a caller ID (CID) display service to be described hereinafter is a service that is provided to a destination subscriber's terminal, and it is assumed that a caller who has an authority provides caller information to a receiver regardless of whether the corresponding receiver has subscribed the CID display service.

Further, it is assumed that the WiMAX and GSM to be described hereinafter are performed by the well known technical standards in a portable Internet and mobile communication technical system.

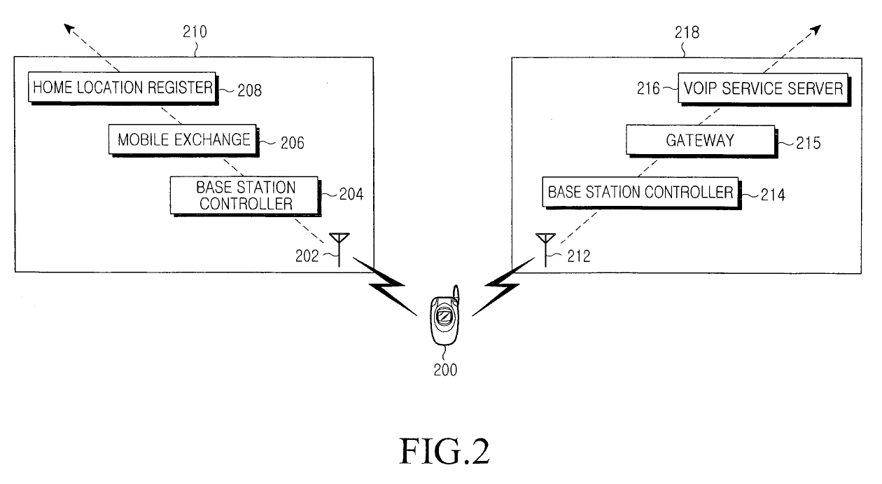

FIG. 2 is a diagram schematically illustrating the whole configuration of a system capable of displaying a caller ID in a WiMAX/GSM integrated support portable terminal according to an embodiment of the present invention. Referring to FIG. 2, the system configuration according to an embodiment of the present invention includes a caller's portable terminal 200, a GSM network 210 and a WiMAX network 218 that are configured in accordance with a mode that is selected when the caller's mobile terminal 200 originates a call, i.e. a mobile communication service mode or a VoIP service mode in which voice service is provided via an IP.

Although not illustrated in detail, the portable terminal 200 includes a ROM, RAM, a display such as an LCD, a CPU, a baseband processor, an audio processor, and a speaker/microphone unit. Further, the portable terminal 200 is provided with an application for supporting the VoIP service, which is stored in the ROM.

The GSM network 210 enables a subscriber who uses the portable terminal 200 to receive a communication service and includes a base station 202 in a wireless communication with the subscriber portable terminal 200, a base station controller 204 that controls the base station 202 and transfers a message between the corresponding base station and a mobile exchange 206, and a home location register (HLR) 208 which connects a call, discriminates an exchange in which the caller is positioned as a caller mobile exchange, and provides a mobile communication service to the portable terminal 200.

The home location register 208 stores and manages subscriber parameters and position information with respect to all terminals registered in its area, and manages main data such as basic services, additional services, and the like, which are provided to the subscriber of the portable terminal 200.

Also, the home location register 208 performs routing such as a voice call of the receiver subscriber, SMS, MMS, and the like, and stores and manages the position of the portable terminal 200 and status information.

As the home location register 208 shares inherent information given to the respective portable terminals, i.e. international mobile station identities (IMSI) that is a non-public value, with the corresponding portable terminal, it manages information necessary for the corresponding portable terminal when connecting a call of the portable terminal 200, and provides the information to a system that requires the information.

Here, the IMSI, which indicates the inherent information of the portable terminal, is an inherent 15-digit identification number that is allocated to the corresponding portable terminal when the terminal subscribes to the GSM service, and the number includes a mobile country code (MCC), a mobile network code (MNC), a mobile subscriber identification number (MSIN), and a country mobile subscriber identification number.

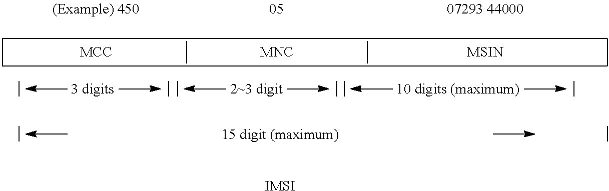

The MCC and MNC uniquely identify a home network of a portable terminal subscriber in any network in the world. In other words, the IMSI has a structure in which another network that provides a roaming service can inquire the home network by analyzing first six digits of the identification number at maximum.

The WiMAX network 218 enables a subscriber who uses the portable terminal 200 to receive the Internet service. The WiMAX network 218 includes a base station 212 in charge of wireless communication with the subscriber portable terminal 200, a base station controller 214 that controls the base station 202 and transfers a message between the corresponding base station and a gateway 215, the gateway 215 providing an interface between the existing mobile communication system or an IP-based network and the portable terminal 200, and a service server converting speed data output from the portable terminal 200 into a digital Internet protocol data packet and provides a VoIP service.

The portable terminal 200 may connect to a service server 216 that provides the VoIP service through the gateway 215 of the WiMAX network 218.

Also, the VoIP service server 216 matches a hash value of the IMSI of the corresponding SIM (Subscriber Identification Module) card of the portable terminal 200 to an MSISDN (Mobile Station International ISDN Number) and stores the matched value.

More specifically, the WiMAX/GSM integrated portable terminal 200 according to an embodiment of the invention connects to the VoIP service server 216 through a specified channel of the WiMAX network 218 in accordance with the voice service on the IP selected to receive the VoIP service. To this end, the VoIP service server 216 transmits a message for confirming whether to perform a caller ID display service, which is in the form of a popup or SMS message, to the portable terminal 200 through the corresponding channel of the WiMAX network 218. This is because the portable terminal that performs integrated support of the WiMAX/GSM according to an embodiment of the present invention simultaneously supports the VoIP service and the GSM service call, and thus a type of user authentication operation for using the VoIP service, which is in the form of a login, is performed by the user, who is not a fixed user, and is changed according to the SIM card provided in the portable terminal.

Meanwhile, the portable terminal 200 that has requested the VoIP service from the VoIP service server 216 receives the message for confirming whether to perform the caller ID display service in the form of a popup or SMS message through the corresponding channel, and then determines whether to perform the caller ID display service. In the case of performing of the caller ID service, the portable terminal 200 includes the corresponding inherent identification information in the SMS and transmits the SMS to the VoIP service server 216.

The inherent identification information represents information assigned to each portable terminal, i.e. a hash value of the IMSI (International Mobile Station Identity) that is a non-public value. The IMSI, which indicates the inherent information of the portable terminal, is an inherent 15-digit identification number that is allocated to the corresponding portable terminal when the terminal subscribes to the GSM service. The identification number includes a mobile country code, a mobile network code, a mobile subscriber identification number, and a country mobile subscriber identification number.

The hash value of the IMSI is acquired by processing the corresponding IMSI with a specified function (“specified function” indicates acquiring a hash value of the IMSI by hashing an IMSI with a hash function, and specifically refers to a value acquired for matching a plurality of data to a small size of table and storing the matched value) and the IMSI is a value that is public to only a network provider, i.e. a type of non-public key value whereby the IMSI can be identified as information shared between the corresponding portable terminal and the service server of the network provider only. It may be a value that is generated so as to prevent the corresponding IMSI value of the portable terminal from being used in an ill-intentional manner such as disguise, tapping, and the like, when the corresponding IMSI value is exposed to the outside.

The portable terminal 200, which intends to receive the VoIP service, generates the hash value of the IMSI by processing its own IMSI value with a specified function, carries the hash value on an SMS, and transfers the SMS to the VoIP service server 216 through the WiMAX network 218.

The VoIP service server 216 confirms the subscriber identification information of the corresponding portable terminal 200 (i.e. the mobile station international ISDN number (MSISDN number) given to the SIM card provided in the portable terminal) through the received SMS, extracts the inherent identification information of the corresponding portable terminal 200 included in the SMS (i.e. the hash value of the IMSI) matches the MSISDN to the hash value of the IMSI, and stores both matched value in a database DB to register the caller ID display service of the corresponding portable terminal 200.

As described above, by matching the corresponding MSISDN of the specified portable terminal to the hash value of the IMSI, storing and managing the matched value, the VoIP service provider 216 recognizes that the caller ID display service has been registered without the necessity of repeated transmission of the message for confirming whether to perform the caller ID display such as a user identification from the same portable terminal of which the MSISDN and the hash value of the IMSI have already been matched together, and directly perform the caller ID display service of the corresponding terminal.

Then, in the case where a specified portable terminal, which has completed the caller ID display service registration process, intends to perform a call origination using the VoIP service, i.e. the portable terminal which intends to connect the originating call, transfers the hash value of its own IMSI to the VoIP service server 216, and the VoIP server 216 searches for the matching MSISDN and the hash value of the IMSI stored and managed in the DB using the transferred hash value of the IMSI. That is, the VoIP server 216 searches for the existence/nonexistence of the MSISDN matching the hash value of the IMSI transmitted from the portable terminal 200, and if there is the MSISDN matching the hash value of the transmitted IMSI as a result of search, the VoIP server 216 recognizes this as a caller ID display service performing command, and makes the receiver side terminal display the MSISDN matching the hash value of the IMSI.

As described above, the whole system configuration of the system that can display a caller ID in the WiMAX/GSM integrated support portable terminal according to an embodiment of the present invention has been briefly described. Hereinafter, a method of displaying a caller ID in a WiMAX/GSM integrated support portable terminal according to an embodiment of the present invention will be described in detail.

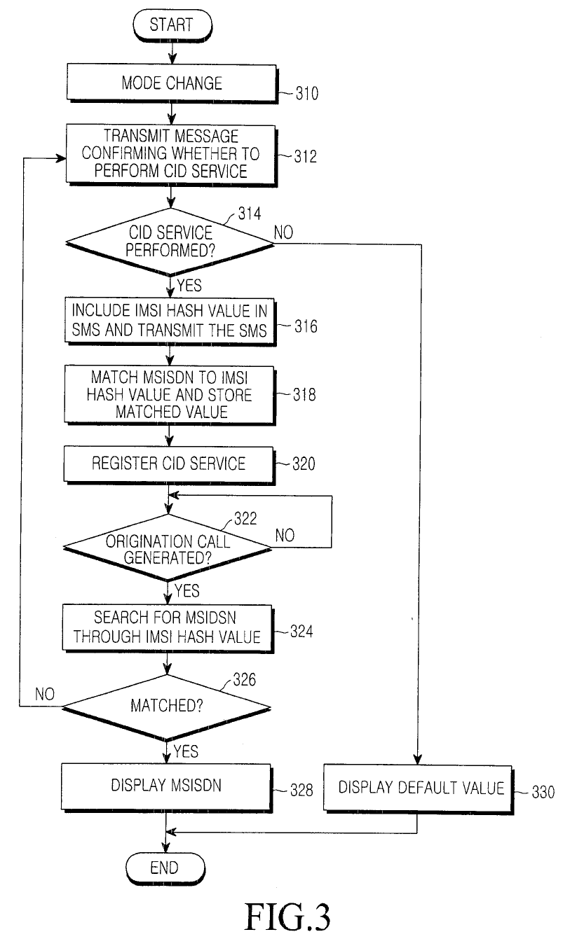

FIG. 3 is a flowchart illustrating a method of displaying a caller ID in a WiMAX/GSM integrated portable terminal according to an embodiment of the present invention.

Referring to FIG. 3, first, in step 310, a mode for selecting a call origination in a caller's portable terminal, that is, a VoIP service mode for providing a voice service on an IP using a WiMAX network or a mobile communication service mode using a GSM network is selected through a mode selection. In the WiMAX/GSM integrated portable terminal according to an embodiment of the present invention, it is assumed that the mode selection to the VoIP service is made to use the VoIP service.

In step 312, the portable terminal connects to the VoIP service server through a specified channel of the WiMAX network according to the selected VoIP service mode, and the VoIP service server transmits a message for confirming whether to perform a caller ID display service, which may be in the form of a popup or SMS message, to the portable terminal through the corresponding channel of the WiMAX network. This is because the portable terminal that performs integrated support of the WiMAX/GSM according to an embodiment of the present invention simultaneously supports the VoIP service and the GSM service call, and thus a user authentication operation for using the VoIP service, which is in the form of a login, is performed as the user, who is not a fixed user, is changed according to the SIM card provided in the portable terminal.

Thereafter, in step 314, the portable terminal, which has requested the VoIP service, confirms whether to perform the caller ID display service in the form of a popup or SMS message through the corresponding channel, and in the case of performing of the caller ID service, the portable terminal includes the corresponding inherent identification information in the SMS and transmits the SMS to the VoIP service server in step 316.

Here, the inherent identification information represents information given to each portable terminal, i.e. a hash value of the IMSI (International Mobile Station Identity) that is a non-public value. The IMSI is an inherent 15-digit identification number that is allocated to the corresponding portable terminal when the terminal subscribes to the GSM service, and includes a mobile country code, a mobile network code, a mobile subscriber identification number, and a country mobile subscriber identification number.

Also, the hash value of the IMSI is acquired by processing the corresponding IMSI with a specified function. The IMSI is a value that is public to only a network provider, i.e. a type of non-public key value whereby the IMSI can be identified as information shared between the corresponding portable terminal and the service server of the network provider only.

In step 318, the VoIP service server, which has received the SMS from the portable terminal, confirms the subscriber identification information of the corresponding portable terminal, i.e. the mobile station international ISDN number (MSISDN number) given to the SIM card provided in the portable terminal, through the received SMS, extracts the inherent identification information of the corresponding portable terminal 200 included in the SMS, i.e. the hash value of the IMSI, matches the MSISDN to the hash value of the IMSI, and stores the matched value in a database DB.

Through the step 318, the caller ID display service of the corresponding portable terminal is registered (step 320).

In step 322, it is checked whether the specified portable terminal generates an originating call, and if the specified portable terminal intends to perform the call origination using the VoIP service, i.e. the portable terminal placing the originating call, transfers the hash value of its own IMSI to the VoIP service server in step 324, and the VoIP server searches for the matching MSISDN and the hash value of the IMSI stored and managed in the DB using the transferred hash value of the IMSI.

That is, the VoIP server searches for the existence/nonexistence of the MSISDN matching the hash value of the IMSI transmitted from the portable terminal in step 326, and if there is the MSISDN matching the hash value of the transmitted IMSI, the VoIP server recognizes this as a caller ID display service performing command, and makes the receiver side terminal display the MSISDN matching the hash value of the IMSI in step 328.

On the other hand, the VoIP server confirms whether the MSISDN matching the hash value of the transmitted IMSI exists, and if the MSISDN does not exist, the VoIP server returns to the step 312 and performs the corresponding process.

Also, if the caller ID display performance is denied as the result of checking in step 314, the VoIP server moves to step 330, and displays a default value on the receiver side terminal that intends to originate the call.

As described above, it should be apparent to those skilled in the art that certain advantages of the system have been achieved. Note that the above-described methods according to the present invention can be realized in the control unit in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the control unit (as represented by a computer, a processor or a programmable hardware) may include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined by the appended claims. According to the present invention as described above, a user on the receiver side can receive a caller ID display service more easily even during a phone call using a VoIP service that is cheaper than a mobile communication service. Also, for the caller ID display of the WiMAX/GSM integrated support portable terminal, the VoIP server matches the corresponding MSISDN of the portable terminal to the hash value of the IMSI, stores and manages the matched values, the communication service that is supported in the existing GSM network can be additionally performed.

What is claimed is:

1. A method of displaying a caller ID in a system supporting both WiMAX and GSM protocol, comprising:
when a service is requested from a portable terminal, transmitting a message for confirming whether to perform a caller ID (CID) display service through a corresponding channel through which the service has been requested;
if the CID display service is to be performed, providing corresponding inherent identification information of the portable terminal in an SMS for transmission;
confirming a subscriber identification information of the corresponding portable terminal through the received SMS by: extracting the inherent identification information included in the SMS, matching the extracted inherent identification information to the subscriber identification information of the portable terminal, and storing the matched identification information; and
registering a caller ID service so that a phone number of the portable terminal can be displayed automatically thereafter.

2. The method as claimed in claim 1, further comprising searching for the existence/nonexistence of the corresponding subscriber identification information through the inherent identification information transmitted from the portable terminal that intends to establish a service originating call, and if there is a match, displaying a corresponding phone number of the portable terminal on a receiver terminal.

3. The method as claimed in claim 1, wherein the inherent identification information comprises a hash value of an IMSI (International Mobile Station Identification) that is allocated during a subscription of the GSM service.

4. The method as claimed in claim 1, wherein the service request from the portable terminal is performed when a mode is changed to a VoIP (Voiceover Internet Protocol) service through a WiMAX network.

5. The method as claimed in claim 1, wherein the subscriber identification information is a MSISDN (Mobile Station International ISDN Number) given to an SIM card provided in the portable terminal

6. The method as claimed in claim 2, wherein if the inherent identification information is not matched, the message for confirming the CID service is transmitted to the corresponding terminal, and if there is no response for a predetermined time period, a number set by default is displayed on the receiver side terminal.

7. The method as claimed in claim 3, wherein the inherent identification information is used for storing and searching for the corresponding data, and is acquired by processing the IMSI given to the portable terminal with a specified function.

8. The method as claimed in claim 1, wherein the message for confirming whether to perform the CID service is displayed in the form of a popup or an SMS message.

9. A network having a first system and a second system, the network providing a caller ID service, comprising:
a terminal, in communication with the first system and the second system, transmitting a request to register for a caller ID (CID) display service via a specified channel of the second system by providing corresponding inherent identification information of the terminal in an SMS; and
a server, in response to the SMS, confirming a subscriber identification information of the terminal by extracting the inherent identification information included in the SMS, matching the extracted inherent identification information to the subscriber identification information, storing both the matched identification information for registration of a caller ID service so that a phone number of the terminal can be displayed automatically thereafter.

10. The network of claim 9, wherein the terminal connects to the VoIP server through a specified channel of WiMAX network that is selected to receive the VoIP service.

11. The network of claim 9, upon receiving a request for a call origination from the terminal to a receiver terminal, displaying a corresponding phone number of the terminal on the receiver side terminal if there is a match between the inherent identification information transmitted from the terminal and previously stored subscriber identification information.

12. The network of claim 9, wherein the inherent identification information comprises a hash value of an IMSI (International Mobile Station Identification) that is allocated during a subscription.

13. The network of claim 9, wherein the subscriber identification information is a MSISDN (Mobile Station International ISDN Number) given to an SIM card provided in the terminal

14. The network of claim 9, wherein the terminal is a WiMAX/GSM integrated portable terminal.

15. The network of claim 9, wherein the first system is a GSM network and the second system is a WiMAX network.
